(19) United States
(12) Patent Application Publication
(10) Pub. No.: US 2003/0126623 A1
(43) Pub. Date: Jul. 3, 2003

(54) Audio/video network, system and method for providing audio

(75) Inventors: Hiroshi Hara, San Diego, CA (US); Tohru Doumuki, San Diego, CA (US)

Correspondence Address: Sony Electronics Inc., MZ 7190, 16450 West Bernardo Drive, San Diego, CA, 92127-1898, US

(73) Assignee: Sony Electronics Inc.

(21) Appl. No.: 10/038,316

(22) Filed: Jan. 2, 2002

(51) Int. Cl. H04N 7/16

(52) U.S. Cl. 725/153

(57) ABSTRACT

An audio/video (AV) network, system, and method is provided which prevents audio blackout in an AV home system. The AV network includes a first device configured to decode an audio signal which comes on the transport stream with a standard definition signal as well as a high definition signal, while a high definition video signal is passed through a digital connection, for example an i.LINK™, to a second device for decoding. In one embodiment, the first device is a set top box and the second device is a high definition television. In another embodiment, the first device and the second device form an audio/video network through the digital connection. In a further embodiment, the AV network forms a part of the home AV system.

### CROSS REFERENCE TO RELATED DOCUMENTS

This application incorporates herein by reference patent application Ser. No. ______, (Sony IPD 50R4872), filed concurrently herewith, by Hiroshi Hara, entitled A SYNCHRONIZATION NETWORK, SYSTEM AND METHOD FOR SYNCHRONIZING AUDIO.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### FIELD OF THE INVENTION

This invention relates generally to the field of home audio/video network systems. More particularly, this invention relates to the use of a network audio/video system to provide seamless audio reproduction.

### BACKGROUND OF THE INVENTION

A typical home audiovisual equipment set up includes a number of components and peripheral devices, such as, for example, an audio/video (AV) amplifier, a DVD/CD player, speakers, a television, a VCR, and the like. Each of these components are connected to each other via a set of wires, with one component usually being central to a home audiovisual system. This is usually the AV amplifier, or a receiver. The AV amplifier has a number of specific inputs for coupling the other components and peripheral devices.

The coupling of the other components and peripheral devices is typically accomplished through the use of Sony Philips Digital Interface Format (SPDIF) connectors, with the AV amplifier having a corresponding number of control buttons or control switches which provide a limited degree of controllability and interoperability for the coupled components and peripheral devices. The user controls the home audiovisual system by manipulating the buttons or switches on the front of the AV amplifier, or alternatively, manipulating buttons on a hand-held remote control unit.

This conventional home AV system paradigm has become quite popular. However, the emergence of networking and interface technology (e.g., IEEE 1394 serial communication bus, DVI, and the wide spread adoption of digital systems) promises a whole new paradigm of home AV peripheral devices and services. The latest and most popular consumer AV peripheral devices (e,g., digital or High Definition TV, DVD players, digital camcorders, mini-disk players, and the like) are based upon digital technology. These AV peripheral devices include sophisticated embedded computer systems.

These AV peripheral devices deliver greatly enhanced functionality and features, as their embedded systems execute elaborate software-based algorithms and are highly configurable, depending upon the desires and taste of the user. The digital nature of the devices allow them to be readily networked into a coherent digital home AV network. Several standards have emerged which define the interfaces and connections for such networks. Currently, the most popular transport technology for digital home AV networks is IEEE 1394. The IEEE 1394 serial bus, often referred to as FireWire™ or i.LINK™, provides a high bandwidth communications protocol upon which an open, intelligent, self-configuring, extensible home AV network architecture can be implemented.

However, while the nature and capabilities of home AV systems have changed dramatically with the advent of i.LINK™ and AV peripheral devices, the ability to provide controllability and interoperability for the coupled components and peripheral devices has decreased in certain regards. For example, when the i.LINK™ is connected to a set top box and networked to the home AV system, and a signal changes from a standard definition/analog signal to a high definition signal, the AV amplifier can not provide audio to the home AV system due to the high definition signal being passed through the i.LINK™ to the high definition TV. Further, when utilizing the graphical user interface (GUI) of the set top box, the user is unable to change the audio input in the AV amplifier between the high definition TV and the set top box and is again unable to provide audio to the home AV system.

### SUMMARY OF THE INVENTION

In view of the foregoing, an audio network, system, and method is provided that solves the audio blackout situations mentioned above.

In particular, a first device is utilized to decode an audio signal associated with a standard definition television signal as well as the high definition television signal, while a high definition video signal is passed through a network digital connection, for example an i.LINK™, to a second device. In one embodiment, the first device is a set-top box and the second device is a high definition television. In another embodiment, the first device and the second device form an audio/video (AV) network through the network connection. In a further embodiment, the AV network forms a part of the home AV system.

These and other features and advantages of the invention will be understood upon the consideration of the following detailed description of the invention and accompanying drawings. The features of the invention believed to be novel are set forth with particularity in the appended claims. The invention itself however, both as to organization and method of operation, together with further objects and advantages thereof, may be best understood by reference to the following description taken in conjunction with the accompanying drawings.

### BRIEF DESCRIPTION OF THE DRAWINGS

The following detailed description, given by way of example, and not intended to limit the present invention solely thereto, will best be understood in conjunction with the accompanying drawings in which:

FIG. 1 is a block diagram of one embodiment of a home AV network.

FIG. 2 is a block diagram of one embodiment of the operation of the AV network shown in FIG. 1 utilizing a high definition signal.

FIG. 3 is a block diagram of another embodiment of the operation of the AV network shown in FIG. 1 utilizing the high definition signal.

FIG. 4 is a block diagram of the home AV network in a home AV system.

### DETAILED DESCRIPTION OF THE INVENTION

While the present invention has been particularly shown and described with reference to the embodiment(s), it will be understood that various changes and modifications may be made without departing from the spirit and scope of this invention. It is intended that the appended claims be interpreted to cover the embodiments described herein and all equivalents thereto.

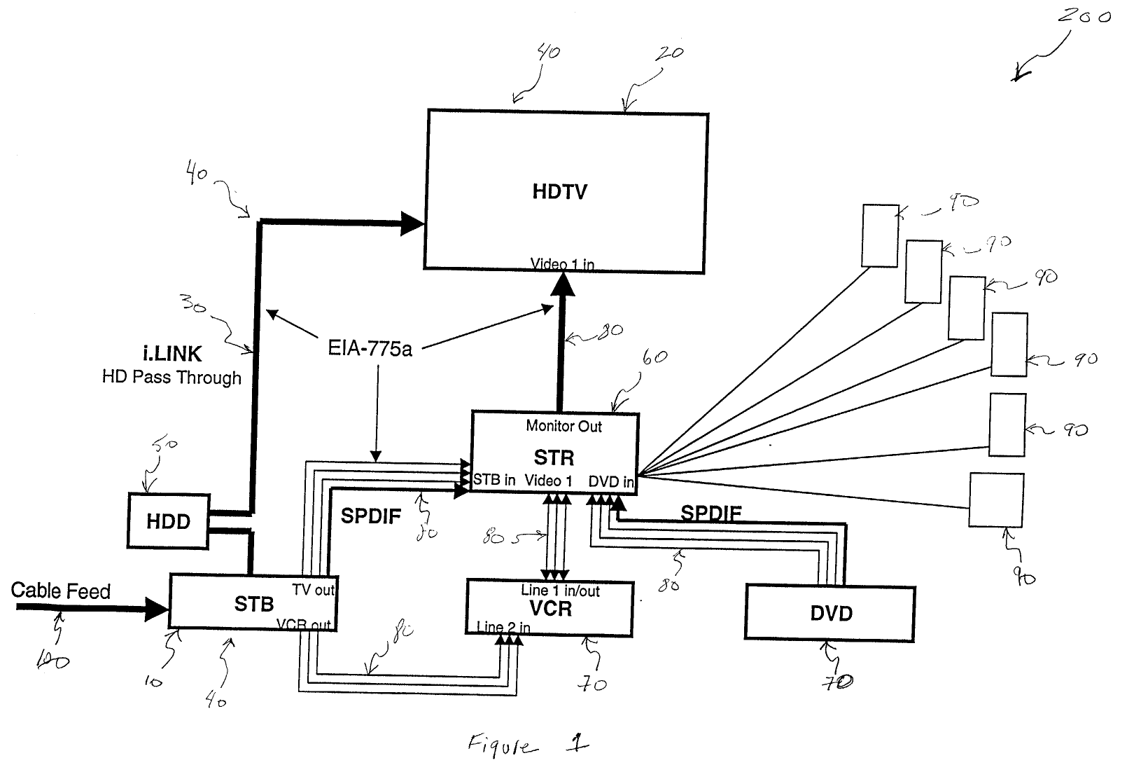

Turning now to FIG. 1, one embodiment of a home AV network 200 is shown.

In one embodiment, AV network 200 includes a first device, a set-top box (STB), 10 in electrical communication with a second device, a high definition television (HDTV) 20 through a digital connection 30. AV network 200 also includes an AV amplifier 40 in electrical communication with STB 10, HDTV 20, and at least one speaker 50. STB 10 is configured to decode an audio signal and HDTV 20 is configured to decode a video signal. STB 10 includes a first decoder 60 that is configured to decode the audio signal, and a first buffer 70 that is configured to store a decoded audio signal. First decoder 60 is in electrical communication with first buffer 70. HDTV 20 includes a second decoder 80, that is configured to decode the video signal, in electrical communication with a second buffer 90, that is configured to store a decoded video signal. AV amplifier 40 includes at least one signal decoder 100 in electrical communication with a third buffer 110. In another embodiment, AV network 200 includes at least one synchronization circuit (not shown) in electrical communication with at least first buffer 70 and second buffer 90. AV network 200 receives and transmits data packets/signals utilizing electrical communication between STB 10 and HDTV 20 selected from the group consisting of a USB protocol, an IEEE 1394 protocol, a RS-232C protocol, a wireless format, DVI, DMI, Cat. 5, telephone line, power line, and an IrDA protocol.

AV amplifier 40 is in electrical communication with STB 10 and HDTV 20 through the use of analog 120 and/or digital 130 connections. AV amplifier 40 receives and transmits AV data packets/signals utilizing analog connections 120 selected from the group consisting of YPbPr, S-Video, Cat. 5, RCA, and RF Coaxial. AV amplifier 40 receives and transmits AV data packets/signals utilizing digital connection 130 selected from the group consisting of USB protocol, IEEE 1394 protocol, RS-232C protocol, a wireless format, DVI, DMI, Cat. 5, telephone line, power line, IrDA protocol, and Sony Philips Digital Interface Format (SPDIF) connectors. In another embodiment, AV amplifier 40 includes the synchronization circuit that is in electrical communication with first buffer 70 and second buffer 90. The synchronization circuit receives and transmits data packets/signals utilizing electrical communication with first buffer 70 and second buffer 90 selected from the group consisting of a USB protocol, an IEEE 1394 protocol, a RS-232C protocol, a wireless format, DVI, DMI, Cat. 5, telephone line, power line, IrDA protocol, SPDIF connectors, YPbPr, S-Video, RCA, and RF Coaxial.

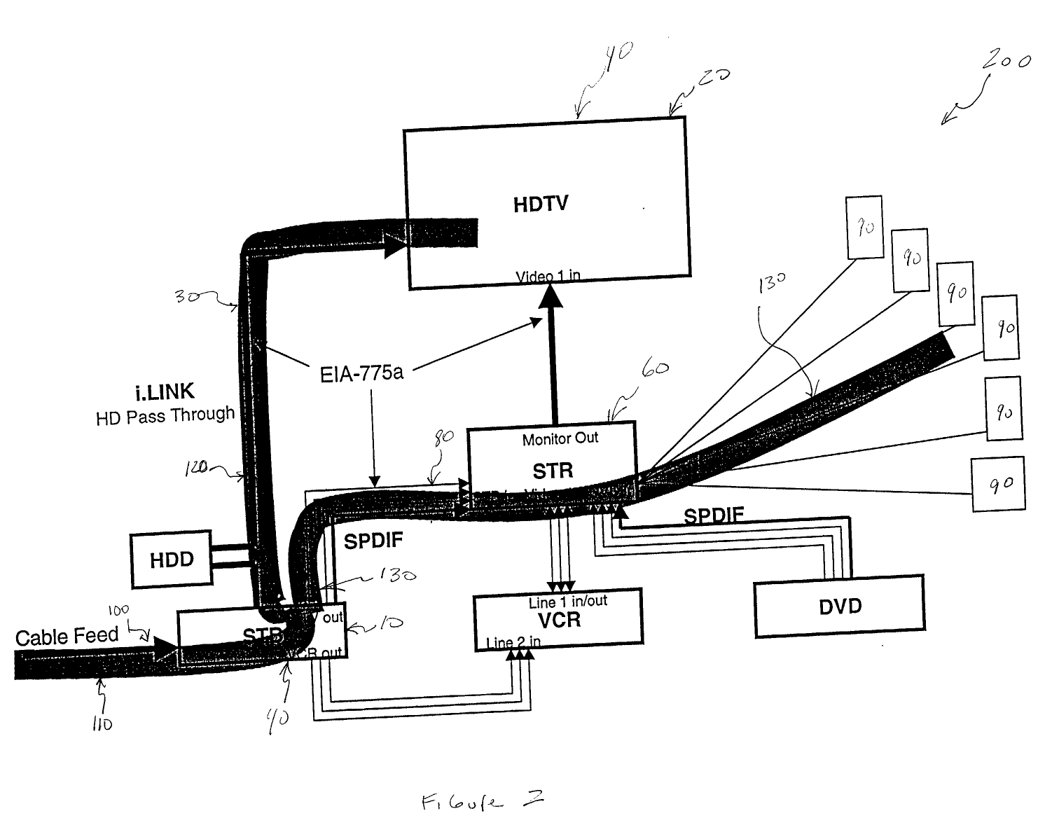

In operation, a signal feed 140 transmits a standard definition/analog signal (not shown) and a high definition signal (shown in FIG. 2) to STB 10. In the case of the standard definition signal, STB 10 decodes the standard definition signal and forwards the received and decoded signal to AV amplifier 40 through analog 120 or digital 130 connections. The decoded audio signal is then forwarded to speakers 50 while the decoded video signal is forwarded to HDTV 20 through analog 120 or digital 130 connections.

FIG. 2 illustrates one embodiment of the operation of AV network 200 (shown in FIG. 1). In the case of a high definition signal 150, signal feed 140 provides high definition signal 150 to STB 10. A high definition video signal 160 is automatically delivered through AV network 200 and passed through digital connection 30 to HDTV 20 where video signal 160 is processed and decoded. An audio signal (not shown) is processed and decoded in STB 10 with a decoded audio signal 170 stored in first buffer 70 in STB 10.

Decoded audio signal 170 is then forwarded to AV amplifier 40 through analog 120 or digital 130 connections, and then transmitted to speakers 50. In one embodiment, AV amplifier 40 includes the synchronization circuit that is in electrical communication with first buffer 70. The synchronization circuit receives and transmits data packets/signals utilizing electrical communication with first buffer 70 selected from the group consisting of a USB protocol, an IEEE 1394 protocol, a RS-232C protocol, a wireless format, DVI, DMI, Cat. 5, telephone line, power line, IrDA protocol, SPDIF connectors, YPbPr, S-Video, RCA, and RF Coaxial.

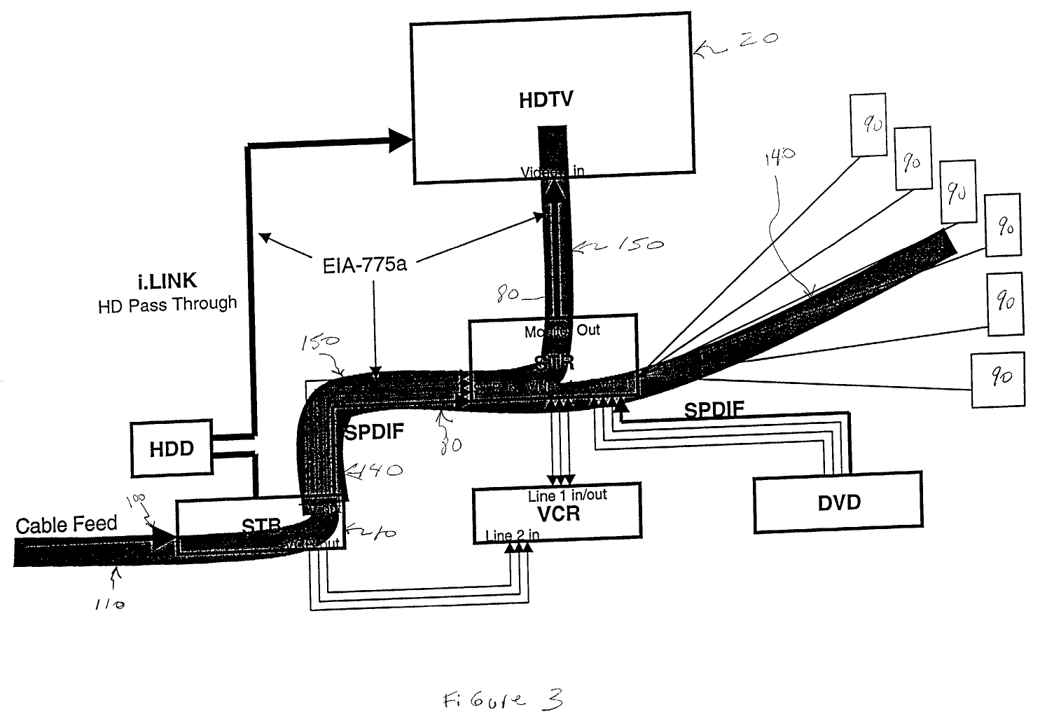

FIG. 3 illustrates another embodiment of the operation of AV network 200 (shown in FIG. 1). In the case where a user selects a graphical user interface (GUI) (not shown) of STB 10, high definition signal 150 is directed through signal feed 140 to STB 10. An audio signal (not shown) is processed and decoded in STB 10 with decoded audio signal 170 stored in first buffer 70 in STB 10. A GUI signal 180 is generated by STB 10 and both decoded audio signal 170 and GUI signal 180 are forwarded to AV amplifier 40 through analog 120 or digital 130 connections and transmitted to speakers 50 and HDTV 20, respectively.

In one embodiment, AV amplifier 40 includes the synchronization circuit that is in electrical communication with first buffer 70 and second buffer 90. The synchronization circuit receives and transmits data packets/signals utilizing electrical communication with first buffer 70 selected from the group consisting of. In another embodiment, a synchronized audio or video signal is stored in third buffer 110 and transmitted to HDTV 20 or speakers 50 utilizing electrical communication selected from the group consisting of a USB protocol, an IEEE 1394 protocol, a RS-232C protocol, a wireless format, DVI, DMI, Cat. 5, telephone line, power line, IrDA protocol, SPDIF connectors, YPbPr, S-Video, RCA, and RF Coaxial. The synchronized audio signal may still need to be decoded and in that instance signal decoder 100 will further decode decoded audio signal 170.

FIG. 4 illustrates home AV network 200 (shown in FIGS. 1, 2, and 3) incorporated into a home AV system 250. In a further embodiment, AV network 200 may include a hard disk drive (HDD) 190 for storing data packets/signals. The standard definition signal, as well as high definition signal 150 (shown in FIGS. 2 and 3), may be stored on HDD 190 in a coded or decoded format, or some variation of a coded or decoded format. AV system 250 also includes a peripheral device 210 that is selected from the group consisting of a VCR, a DVD player/recorder, and any digital audio/video device. AV system 250 operates as normal, with peripheral devices 210 forwarding their audio and video signals to AV amplifier 40 through analog 120 or digital 130 connections to HDTV 20 and speakers 50.

Various other modifications and alterations in the structure and method of operation of this invention will be apparent to those skilled in the art, without departing from the scope and spirit of the invention. Although the invention has been described in connection with specified preferred embodiments, it should be understood that the invention as claimed should not be unduly limited to such specific embodiments. It is intended that the following claims describe the scope of the present invention and that the structures and methods within the scope of these claims and their equivalents be covered thereby.

What is claimed is:

1. A method for providing audio in an audio/video network, said method comprises:
providing an audio signal and a video signal to a first device in the audio/video network; and
processing said video signal in a second device.

2. A method for providing audio in an audio/video network as recited in claim 1, wherein providing an audio signal and a video signal to a first device in the audio/video network comprises:
processing said audio signal in said first device; and
delivering said video signal from said first device to said second device.

3. A method for providing audio in an audio/video network as recited in claim 2, wherein processing said audio signal in said first device comprises decoding said audio signal in said first device.

4. A method for providing audio in an audio/video network as recited in claim 3, wherein said method further comprises storing a decoded audio signal in a first buffer in said first device.

5. A method for providing audio in an audio/video network as recited in claim 4, wherein said first device selected from the group consisting of a set top box, an audio/video receiver, and any equivalent computing device(s).

6. A method for providing audio in an audio/video network as recited in claim 2, wherein delivering said video signal from said first device to said second device comprises utilizing at least one means for connecting said first device to said second device selected from the group consisting of a USB protocol, an IEEE 1394 protocol, a RS-232C protocol, a wireless format, DVI, DMI, Cat. 5, telephone line, power line, and an IrDA protocol.

7. A method for providing audio in an audio/video network as recited in claim 1, wherein processing said video signal in a second device comprises decoding said video signal in said second device.

8. A method for providing audio in an audio/video network as recited in claim 7, wherein said method further comprises storing a decoded video signal in a second buffer in said second device.

9. A method for providing audio in an audio/video network as recited in claim 8, wherein said method further comprises synchronizing an output of a first buffer with an output of said second buffer.

10. An audio/video network comprising:
a first device configured to decode an audio signal; and
a second device configured to decode a video signal, said first device in electrical communication with said second device.

11. An audio/video network as recited in claim 10, wherein said first device includes a first decoder configured to decode said audio signal.

12. An audio/video network as recited in claim 11, wherein said first device further includes a first buffer configured to store a decoded audio signal.

13. An audio/video network as recited in claim 10, wherein said second device includes a second decoder configured to decode said video signal.

14. An audio/video network as recited in claim 13, wherein said second device further includes a second buffer configured to store a decoded video signal.

15. An audio/video network as recited in claim 14, further comprising at least one synchronization circuit in electrical communication with a first buffer and said second buffer.

16. An audio/video network as recited in claims 15, wherein at least one means for electrical communication between said first device and said second device selected from the group consisting of a a USB protocol, an IEEE 1394 protocol, a RS-232C protocol, a wireless format, DVI, DMI, Cat. 5, telephone line, power line, and an IrDA protocol.

17. An audio/video system comprises:
a first device, including a standard signal decoder;
a second device, including a high definition signal decoder, said first device in electrical communication with said second device; and
at least one peripheral device in electrical communication with said first device and said second device.

18. An audio/video system as recited in claim 17, wherein said first device further includes a first buffer in electrical communication with said standard signal decoder, said first buffer in electrical communication with said second device.

19. An audio/video system as recited in claim 18, wherein said second device further includes a second buffer in electrical communication with said high definition signal decoder, said second buffer in electrical communication with said first device, said first buffer and said second buffer further in electrical communication with said peripheral device.

20. An audio/video system as recited in claim 19, wherein said peripheral device is selected from the group consisting of an audio/video amplifier, a VCR, a DVD player/recorder, and any other digital audio/video device(s).

21. An audio/video system as recited in claim 19 wherein said peripheral device includes a synchronization circuit in electrical communication with said first buffer and said second buffer.

22. An audio/video system as recited in claim 21, wherein at least one means for electrical communication selected from the group consisting of a a USB protocol, an IEEE 1394 protocol, a RS-232C protocol, a wireless format, DVI, DMI, Cat. 5, telephone line, power line, and an IrDA protocol.
